(19) United States
(12) Patent Application Publication
(10) Pub. No.: US 2026/0277196 A1
(43) Pub. Date: Sep. 17, 2026

(54) LEADING INDICATOR FOR OVERALL PLANT HEALTH USING PROCESS DATA AUGMENTED WITH NATURAL LANGUAGE PROCESSING FROM MULTIPLE SOURCES

(71) Applicant: Dow Global Technologies LLC, Midland, MI (US)

(72) Inventors: Birgit Braun, Lake Jackson, TX (US); Yan Ma, Shanghai (CN); Swee-Teng Chin, Freeport, TX (US); Ivan Castillo, Lake Jackson, TX (US); Zhenyu Wang, Lake Jackson, TX (US); You Peng, Midland, MI (US); Leo H. Chiang, Freeport, TX (US)

(73) Assignee: Dow Global Technologies LLC, Midland, MI (US)

(21) Appl. No.: 19/168,100

(22) PCT Filed: Mar. 30, 2023
(86) PCT No.: PCT/CN2023/085236

§ 371 Date: Sep. 23, 2025

(51) Int. Cl. G05B 19/418; G06F 40/166; G06F 40/279; G06F 40/40

(52) U.S. Cl. CPC G05B 19/41835; G06F 40/166; G06F 40/279; G06F 40/40; G05B 2219/31001

(57) ABSTRACT

A method may include receiving binary data associated with one or more pieces of equipment in a manufacturing plant, the binary data indicating whether one or more performance variables associated with the one or more pieces of equipment were outside of a predetermined range; receiving text data associated with the one or more pieces of equipment in the manufacturing plant; performing a vectorization of the text data using natural language processing techniques to obtain vectorized data; receiving unplanned event data indicating unplanned events and associated pre-failure periods; and using the binary data, the vectorized data, and the unplanned event data to train a machine learning model to classify a state of the manufacturing plant between a normal operating period and a pre-failure period.

### TECHNICAL FIELD

The present specification relates to monitoring the health of manufacturing plants, and more particularly, to systems and methods for determining a leading indicator for overall plant health using process data augmented with natural language processing from multiple sources.

### BACKGROUND

In chemical, or other types of manufacturing plants, unplanned events can cause significant production losses. As such, predicting such unplanned events before they occur may allow corrective action to be taken to avoid any consequent production losses. Unplanned events may be predicted based on measurements of various pieces of equipment in a manufacturing plant. However, in addition to numerical values taken from equipment measurements, manufacturing plants also generate text data, such as work orders or shift change logs. As such, it may be desirable to estimate the health of a manufacturing plant using text data in addition to numerical measurements taken from equipment in the plant.

### SUMMARY

In one embodiment, a method may include receiving binary data associated with one or more pieces of equipment in a manufacturing plant. The binary data may indicate whether one or more performance variables associated with the one or more pieces of equipment were outside of a predetermined range. The method may further include receiving text data associated with the one or more pieces of equipment in the manufacturing plant. The method may further include performing a vectorization of the text data using natural language processing techniques to obtain vectorized data. The method may further include receiving unplanned event data indicating unplanned events and associated pre-failure periods. The method may further include using the binary data, the vectorized data, and the unplanned event data to train a machine learning model to classify a state of the manufacturing plant between a normal operating period and a pre-failure period.

In another embodiment, a computing device may include a processor configured to receive binary data associated with one or more pieces of equipment in a manufacturing plant. The binary data may indicate whether one or more performance variables associated with the one or more pieces of equipment were outside of a predetermined range. The processor may further receive text data associated with the one or more pieces of equipment in the manufacturing plant. The processor may further perform a vectorization of the text data using natural language processing techniques to obtain vectorized data. The processor may further receive unplanned event data indicating unplanned events and associated pre-failure periods. The processor may further use the binary data, the vectorized data, and the unplanned event data to train a machine learning model to classify a state of the manufacturing plant between a normal operating period and a pre-failure period.

In another embodiment, a system may include one or more pieces of equipment in a manufacturing plant and a computing device with a processor. The processor may be configured to receive binary data associated with one or more pieces of equipment in a manufacturing plant. The binary data may indicate whether one or more performance variables associated with the one or more pieces of equipment were outside of a predetermined range. The processor may further receive text data associated with the one or more pieces of equipment in the manufacturing plant. The processor may further perform a vectorization of the text data using natural language processing techniques to obtain vectorized data. The processor may further receive unplanned event data indicating unplanned events and associated pre-failure periods. The processor may further use the binary data, the vectorized data, and the unplanned event data to train a machine learning model to classify a state of the manufacturing plant between a normal operating period and a pre-failure period.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 schematically depicts an example manufacturing plant, according to one or more embodiments shown and described herein;

FIG. 2 depicts an example computing device, according to one or more embodiments shown and described herein;

FIG. 3 schematically depicts a plurality of memory modules of the computing device of FIG. 2, according to one or more embodiments shown and described herein;

FIG. 4A depicts example categorical data, according to one or more embodiments shown and described herein;

FIG. 4B depicts example binary data, according to one or more embodiments shown and described herein;

FIG. 5 schematically depicts a machine learning architecture, according to one or more embodiments shown and described herein;

FIG. 6 depicts a flowchart of an example method for training the machine learning model of FIG. 5, according to one or more embodiments shown and described herein; and

FIG. 7 depicts a flowchart of an example method for utilizing the machine learning model of FIG. 5, according to one or more embodiments shown and described herein.

### DETAILED DESCRIPTION

The embodiments disclosed herein describe systems and methods for determining a leading indicator for overall plant health using process data augmented with natural language processing from multiple sources. In particular, a leading indicator may indicate a likelihood that a manufacturing plant will experienced an unplanned event that reduces a production level of the manufacturing plant or causes a containment event.

In embodiments, a variety of data is collected from a manufacturing plant, including numerical data associated with plant equipment and text data. The numerical data may be associated with measurement values from the plant equipment and the text data may comprise notes and writings of humans in the plant. Natural language processing is utilized to convert the text data to numerical values. The numerical data and the numerical values of the text data may be combined, and the combined data may be utilized to predict the likelihood of an unplanned event.

In embodiments, a machine learning model may be trained to predict a likelihood of an unplanned event occurring at a manufacturing plant, as disclosed herein. Historical data including numerical data and text data for past time periods at a manufacturing plant may be gathered as training data. Indications as to whether unplanned events occurred may also be gathered as ground truth values. A machine learning model (e.g., a neural network) may then be trained to predict a likelihood of an unplanned event based on the training data and the ground truth values. Once the model is trained, the model may be used to make predictions about future unplanned events based on data collected in real time. When an unplanned event is predicted, corrective action may be performed to prevent the unplanned action from occurring, thereby increasing the overall productivity of the manufacturing plant.

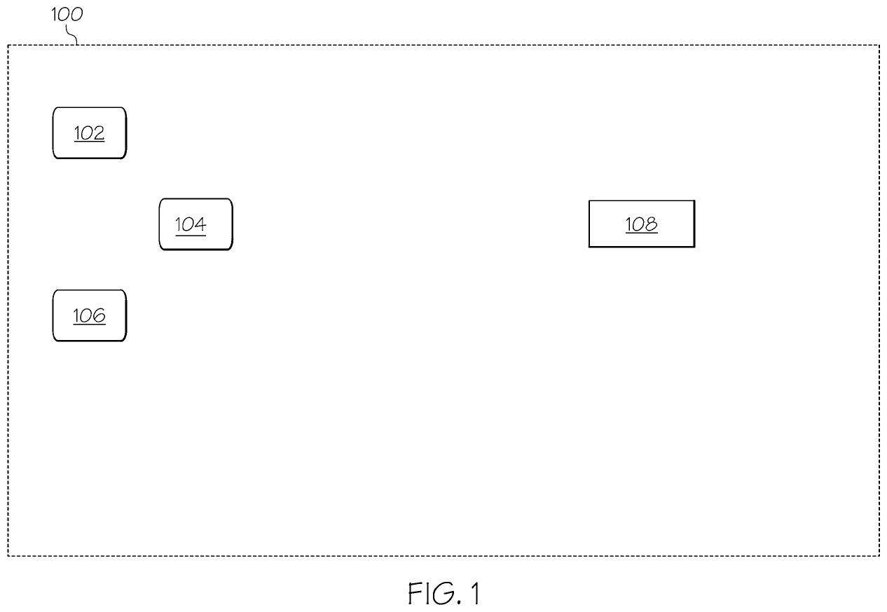

Turning now to the figures, FIG. 1 schematically depicts a manufacturing plant 100. The manufacturing plant 100 comprises plant equipment 102, 104, 106, and a computing device 108. In the example of FIG. 1, the manufacturing plant 100 comprises three pieces of equipment. However, it should be understood that in other examples, the manufacturing plant may comprise any number of pieces of equipment.

In the example of FIG. 1, the equipment 102, 104, 106 may perform various operations associated with the manufacturing plant 100. The equipment 102, 104, 106 may also include a variety of sensors that measure one or more properties of the equipment. For example, sensors may measure properties of the equipment such as temperature, pressure, flow rate, and the like. In some examples, the equipment 102, 104, 106 may record alarm data based on measured values of equipment properties. Alarm data may comprise binary data or categorical data. Binary alarm data may indicate whether or not a particular measured value of plant equipment is above or below a particular threshold. For example, binary alarm data may indicate that the equipment 102 has recorded a temperature above a threshold temperature. Categorical alarm data may indicate the status of equipment properties in a non-binary manner. For example, categorical alarm data may indicate which of a plurality of alarms have been triggered (e.g., which of a plurality of measured properties are above or below predetermined thresholds). In other examples, categorical alarm data may indicate sensor data in another non-binary manner, such as whether a measured value is low, medium, or high.

In addition to alarm data, employees or other people associated with the manufacturing plant 100 may record text data associated with the equipment 102, 104, 106. For example, employees may fill out work orders, shift change notes, and the like. This text data may indicate qualitative information about the operation of the manufacturing plant 100 and the equipment 104, 104, 106. The computing device 108 may utilize text data in addition to numerical data (e.g., binary data or categorical data) to predict a likelihood of an unplanned event occurring in the manufacturing plant 100 at a future time. By utilizing text data in addition to numerical data, the computing device 108 may make more accurate predictions about future unplanned events.

Referring still to FIG. 1, the computing device 108 may receive data from the equipment 102, 104, 106, as disclosed herein. The computing device 108 may utilize the received data to train a machine learning model to predict a likelihood of an unplanned event occurring in the manufacturing plant 100. As utilized herein, an unplanned event may be an event that causes a significant loss of production. For example, an unplanned event may be an event that causes a production level of the manufacturing plant 100 to decrease by more than a predetermined threshold amount. In some examples, an unplanned event may be safety related. In some examples, an unplanned event may be an unintended process release event (e.g., an event that causes a contaminant to be released into the environment of the manufacturing plant 100).

In the illustrated example, the computing device 108 may receive binary and/or categorical alarm data from the equipment 102, 104, 106. In some examples, the computing device 108 may receive raw sensor data (e.g., time series data of measured sensor values) from the equipment 102, 104, 106. In some examples, the computing device 108 may receive a combination of binary alarm data, categorical alarm data, and time series data from the equipment 102, 104, 106. The computing device 108 may also receive text data recorded by employees of the manufacturing plant 100 (e.g., text files comprising work orders, shift changes notes, and the like). As disclosed in further detail below, the computing device 108 may utilize the received data to predict a likelihood of the manufacturing plant 100 experiencing an unplanned event.

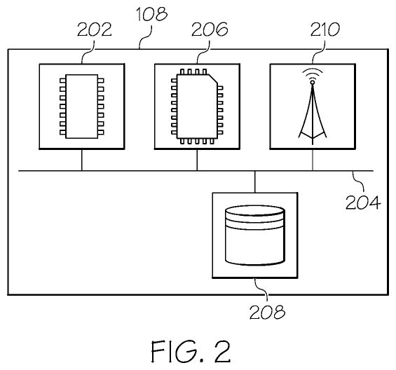

FIG. 2 schematically depicts an example configuration of the computing device 108 of FIG. 1. In some examples, the computing device 108 may be located inside of the manufacturing plant 100. In other examples, the computing device 108 may be an external computing device (e.g., a cloud computing device). In the illustrated example, the computing device 108 includes one or more processors 202, a communication path 204, one or more memory modules 206, a data storage component 208, and network interface hardware 210, the details of which will be set forth in the following paragraphs.

Each of the one or more processors 202 may be any device capable of executing machine readable and executable instructions. Accordingly, each of the one or more processors 202 may be a controller, an integrated circuit, a microchip, a computer, or any other physical or cloud-based computing device. The algorithms, including training and operating the machine learning model discussed below, may be executed by the one or more processors 202. The one or more processors 202 are coupled to a communication path 204 that provides signal interconnectivity between various modules of the computing device 108. Accordingly, the communication path 204 may communicatively couple any number of processors 202 with one another, and allow the modules coupled to the communication path 204 to operate in a distributed computing environment. Specifically, each of the modules may operate as a node that may send and/or receive data. As used herein, the term “communicatively coupled” means that coupled components are capable of exchanging data signals with one another such as, for example, electrical signals via conductive medium, electromagnetic signals via air, optical signals via optical waveguides, and the like.

Accordingly, the communication path 204 may be formed from any medium that is capable of transmitting a signal such as, for example, conductive wires, conductive traces, optical waveguides, or the like. In some embodiments, the communication path 204 may facilitate the transmission of wireless signals, such as WiFi, Bluetooth®, Near Field Communication (NFC) and the like. Moreover, the communication path 204 may be formed from a combination of mediums capable of transmitting signals. In one embodiment, the communication path 204 comprises a combination of conductive traces, conductive wires, connectors, and buses that cooperate to permit the transmission of electrical data signals to components such as processors, memories, sensors, input devices, output devices, and communication devices. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium.

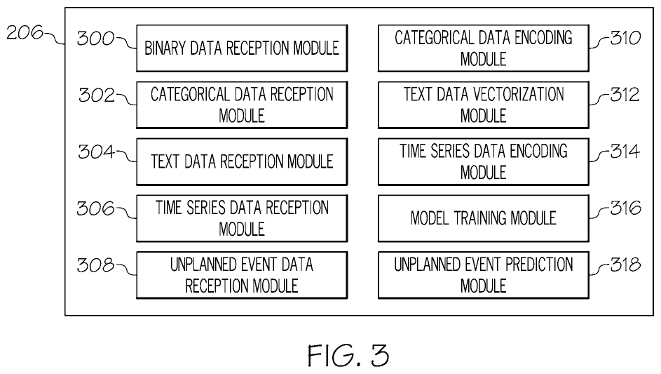

The computing device 108 includes one or more memory modules 206 coupled to the communication path 204. The one or more memory modules 206 may comprise RAM, ROM, flash memories, hard drives, or any device capable of storing machine readable and executable instructions such that the machine readable and executable instructions can be accessed by the one or more processors 202. The machine readable and executable instructions may comprise logic or algorithm(s) written in any programming language of any generation (e.g., 1GL, 2GL, 3GL, 4GL, or 5GL) such as, for example, machine language that may be directly executed by the processor, or assembly language, object-oriented programming (OOP), scripting languages, microcode, etc., that may be compiled or assembled into machine readable and executable instructions and stored on the one or more memory modules 206. Alternatively, the machine readable and executable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components. The memory modules 206 are discussed in more detail below in connection with FIG. 3.

Referring still to FIG. 2, the example computing device 108 includes a data storage component 208. The data storage component 208 may store data received from the equipment 102, 104, 106 or data generated by the computing device 108. The data storage component 208 may also store other data used by the various components of the computing device 108. In particular, the data storage component 208 may store parameters of a machine learning model maintained by the computing device 108 that is utilized to predict a likelihood of the manufacturing plant 100 experiencing an unplanned event. The machine learning model maintained by the computing device 108 may be referred to herein as, “the model”.

Still referring to FIG. 2, the computing device 108 comprises network interface hardware 210 for communicatively coupling the computing device 108 to the equipment 102, 104, 106. As such, the network interface hardware 210 may send data to and/or receive data from the equipment 102, 104, 106. The network interface hardware 210 may comprise a wired and/or wireless connection to the equipment 102, 104, 106. In other examples, the network interface hardware 210 may be send data to and/or receive data from other computing devices. In some examples, the network interface hardware 210 may receive data from sensors associated with the equipment 102, 104 106. In some examples, the network interface hardware 210 may receive data from another computing device that receives data from the equipment 102, 104, 106. In some examples, the network interface hardware 210 may receive data from a computing device that stores text data (e.g., work orders, shift change notes) as described above.

The network interface hardware 210 can be communicatively coupled to the communication path 204 and can be any device capable of transmitting and/or receiving data via a network. Accordingly, the network interface hardware 210 can include a communication transceiver for sending and/or receiving any wired or wireless communication. For example, the network interface hardware 210 may include an antenna, a modem, LAN port, Wi-Fi card, WiMax card, mobile communications hardware, near-field communication hardware, satellite communication hardware and/or any wired or wireless hardware for communicating with the fiber optic cable 216 and/or other networks and/or devices.

Referring now to FIG. 3, the one or more memory modules 206 include a binary data reception module 300, a categorical data reception module 302, a text data reception module 304, a time series data reception module 306, an unplanned event data reception module 308, a categorical data encoding module 310, a text data vectorization module 312, a time series data encoding module 314, a model training module 316, and an unplanned event prediction module 318. Each of the binary data reception module 300, the categorical data reception module 302, the text data reception module 304, the time series data reception module 306, the unplanned event data reception module 308, the categorical data encoding module 310, the text data vectorization module 312, the time series data encoding module 314, the model training module 316, and the unplanned event prediction module 318 may be a program module in the form of operating systems, application program modules, and other program modules stored in one or more memory modules 206. Such a program module may include, but is not limited to, routines, subroutines, programs, objects, components, data structures and the like for performing specific tasks or executing specific data types as will be described below.

The binary data reception module 300 may receive binary data from the equipment 102, 104, 106. In embodiments, binary data may comprise a 1 or a 0 indicating whether or not an alarm has been triggered for a particular piece of equipment during a particular time period. In particular, the binary data may indicate whether one or more performance variables associated with a piece of equipment was outside of a predetermined range indicating acceptable values for the performance variables. For example, an acceptable temperature range for the equipment 102 may indicate a minimum allowable temperature and a maximum allowable temperature at which the equipment 102 should operate. These values may be set based on the particular type of the equipment 102 (e.g., an acceptable operating range set by the manufacturer). If a temperature sensor detects that the temperature of the equipment 102 exceeds the maximum allowable temperature or falls below the minimum allowable temperature, the sensor may trigger an alarm indicating that the temperature of the equipment 102 has fallen outside of the acceptable range.

When an alarm is triggered, alarm data may be recorded indicating that a particular performance variable has been measured as being outside of an acceptable range. In the illustrated example, alarm data indicates whether a particular performance variable was outside of an acceptable range at any time during one particular day. However, in other examples, alarm data may indicate whether a particular performance variable was outside of an acceptable range during other time periods (e.g., during a 1-hour time period, during an 8-hour time period, and the like).

In embodiments, a variety of different alarms may be associated with each piece of equipment in the manufacturing plant 100. For example, a first alarm may indicate whether the temperature of the equipment 102 has exceeded a maximum allowable temperature, a second alarm may indicate whether a temperature of the temperature of the equipment 102 has fallen below a minimum allowable temperature, a third alarm may indicate whether a pressure measurement associated with the equipment 102 has exceeded a maximum allowable pressure, and the like. Each piece of equipment 102, 104, 106 may have a plurality of associated alarms.

The binary data reception module 300 may receive binary alarm data associated with the equipment 102, 104, 106. The alarm data may be input to the machine learning model maintained by the computing device 108 to predict a likelihood of an unplanned event occurring, as disclosed herein.

Referring still to FIG. 3, the categorical data reception module 302 may receive categorical data associated with the equipment 102, 104, 106, as disclosed herein. The categorical data may also indicate whether one or more performance variables associated with the equipment 102, 104, 106 are outside of an acceptable range. However, unlike the binary data, the categorical data does not simply comprise a 1 or 0 indicating whether an alarm was triggered. As such, the categorical data must be encoded in order to be input into the model maintained by the computing device 108, as disclosed herein.

In one example, categorical data may indicate which alarms were triggered during a particular day (or other time period). For example, the categorical data reception module 302 may receive categorical data indicating that on a particular day, alarms 1, 3 and 4 were triggered for equipment 104. In another example, the categorical data reception module 302 may receive categorical indicating whether a particular alarm was low, medium, or high during a particular day. After receiving categorical data, the categorical data may be encoded into binary data indicating whether a particular alarm was triggered so that it can be input into the machine learning model maintained by the computing device 108. Encoding of the categorical data is discussed in further detail below with respect to the categorical data encoding module 310.

Referring still to FIG. 3, the text data reception module 304 may receive text data associated with the equipment 102 104, 106. The text data may come from a variety of sources. In one example, text data may comprise work orders. In another example, text data may comprise logbook entries. In another example, text data may comprise shift change notes. In other examples, text data may comprise any combination of the above and/or any other text associated with the manufacturing plant 100 and/or the equipment 102, 104, 106. In embodiments, the text data may be generated by employees or other workers at the manufacturing plant 100 who interact with the equipment 102, 104, 106. As such, these individuals may have intimate knowledge of the performance or state of the equipment 102, 104, 106. Accordingly, text records created by these individuals may be useful in predicting future unplanned events.

In embodiments, the text data reception module 304 may receive a variety of text data associated with the manufacturing plant 100 and/or the equipment 102, 104, 106 as described above. The text data reception module 304 may also receive a date indicating when each received text record was generated. The computing device 108 may utilize the received text data to train the model to predict future unplanned events, as disclosed in further detail below. In one example, the text data reception module 304 may receive text data in the form of one or more text files. In other examples, the text data reception module 304 may receive text data in any other form.

Referring still to FIG. 3, the time series data reception module 306 may receive time series data associated with the equipment 102, 104, 106. In the examples discussed above, the computing device 108 receives alarm data indicating whether an alarm has been triggered by a performance variable of a particular piece of equipment being outside of an acceptable range during a specified period of time. However, in some examples, rather than receiving alarm data, the time series data reception module 306 may directly receive sensor data indicating sensor measurements taken from the equipment. This sensor data may indicate parameter values of the equipment 102, 104, 106 measured by various sensors over time, and as such, is referred to herein as time series data. For example, time series data received by the time series data reception module 306 may include temperature readings of the equipment 106 over the course of a day (e.g., one reading every 15 minutes). After receiving such time series data, the computing device 108 may determine whether the parameter values indicated by the time series data were outside of an acceptable range, as discussed in further detail below.

Referring still to FIG. 3, the unplanned event data reception module 308 may receive information about unplanned events that occurred at the manufacturing plant 100, as disclosed herein. As discussed above, the computing device 108 may train a model to predict a likelihood of the manufacturing plant 100 experiencing an unplanned event in the future. In particular, the computing device 108 may receive training data that may be used to train the model. The training data may comprise binary data, categorical data, text data and/or time series data, as described above, which may be input to the model. The training data may also comprise unplanned event data to be used as ground truth values during model training. That is, for any particular day, training data may comprise data (e.g., alarm data) associated with the equipment 102, 104, 106 and ground truth values indicating whether or not the manufacturing plant 100 experienced an unplanned event that day. In other words, the unplanned event data may indicate whether the received alarm data is associated with a normal operating condition of the manufacturing plant 100 (when no unplanned event will occur), or with a pre-failure period of the manufacturing plant (when an unplanned event will occur). The training data may then be used to train the model to predict a likelihood of experiencing an unplanned event using the received training data and ground truth values, as disclosed in further detail below.

As discussed above, an unplanned event may comprise an event that causes the production level of the manufacturing plant 100 to be reduced by more than a threshold amount. In some examples, a human may determine whether an unplanned event has occurred based on objective and/or subjective criteria. In other examples, an unplanned event may be automatically determined based on one or more metrics. For example, a volume of a particular product produced each day by the manufacturing plant 100 may be monitored, and if the volume produced for a particular day is below a predetermined threshold amount, it may be determined that an unplanned event has occurred for that day

Referring still to FIG. 3, the categorical data encoding module 310 may encode categorical data received by the categorical data reception module 302. As discussed above, the categorical data reception module 302 may receive categorical data associated with the equipment 102, 104, 106. Accordingly, before the received categorical data can be input into the model, it must be encoded into binary data, as disclosed herein.

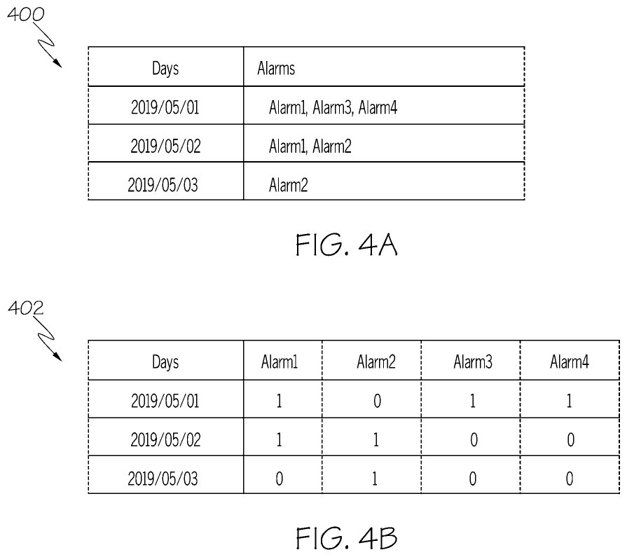

In one example, the categorical data may comprise an indication of which alarms were triggered on different days. In these examples, the categorical data may be one-hot encoded to form a sparse matrix of dummy variables with values of 0 or 1. FIG. 4A shows a table 400 of example categorical data. In the example of FIG. 4A, alarms 1, 3 and 4 were triggered on May 1, 2019, alarms 1 and 2 were triggered on May 2, 2019, and alarm 2 was triggered on May 3, 2019. The example categorical data may be one-hot encoded as shown in table 402 of FIG. 4B. As can be seen in FIG. 4B, for each day, the table 402 comprises a 1 or a 0 for each of alarms 1, 2, 3 or 4 indicating whether the alarm was triggered that day. As such, the binary data of table 402 may be input into the model maintained by the computing device 108. In other examples, the categorical data received by the categorical data reception module 302 may be encoded in other manners to generate binary data.

Referring back to FIG. 3, the text data vectorization module 312 may perform a vectorization of the text data received by the text data reception module 304. As discussed above, the text data reception module 304 may receive text data associated with the manufacturing plant 100 and/or the equipment 102, 104, 106 (e.g., work orders, shift change notes, and the like). However, before the text data can be input to the model maintained by the computing device 108, it must be converted into numerical values, which may be performed by the text data vectorization module 312, as disclosed herein.

The text data received by the text data reception module 304 may comprise descriptive sentences with observations and details about the manufacturing plant 100 and/or the equipment 102, 104, 106. As such, the text data vectorization module 312 may perform natural language processing of the sequence of words in the received text data to convert the text data into numerical values. In the illustrated example, the text data vectorization module 312 performs vectorization on the text data. However, in other examples, the text data vectorization module 312 may perform other types of natural language processing.

Learning a distributed representation of the words of the text data in low dimensional space may significantly improve the efficiency of natural language processing. With distributional vectors of word embedding, words with similar meanings that occur in a similar context are captured with an unsupervised learning approach. The word embeddings try to capture similarities among words, wherein words having a similar meaning or context will show a high similarity score with the vector representation.

In embodiments, the text data vectorization module 312 may aggregate all of the words and sentences from a particular day into a word sequence comprising a single daily entry. The text data vectorization module 312 may then pass the daily entry through a word filter to remove punctuation, stop words, and words with low frequency (e.g., words appearing less than a predetermined percentage of the time) to obtain a filtered word sequence. This filtering process typically reduces the length of the word sequence by some amount, thereby reducing the amount of text data upon which vectorization is performed.

The text data vectorization module 312 may then generate a real-valued vector based on the filtered word sequence using natural language processing or vectorization techniques. In the illustrated example, the text data vectorization module 312 performs vectorization of the filtered word sequence using Global Vectors for Word Representation (GloVe), which comprises a pre-trained vector space of word representations. A vectorization performed by GloVe may produce dimensions of meaning that capture distributed representations. GloVe representations leverage information by training on non-zero elements in a word-word or co-occurrence matrix, which produces meaningful vector space substructure.

In embodiments, the filtered word sequence is vectorized using GloVe to represent each word by a vector of 50 elements. Although the pre-trained GloVe embeddings comprise 40,000 English words, the words of abbreviations of different sections of the manufacturing plant 100 are not available for the pre-trained embedding. In the illustrated example, instead of removing those out-of-vocabulary words, the text data vectorization module 312 assigns a randomly generated vector in a range of [−0.25, 0.25] to bar-code unrecognized words from the GloVe dictionary. While the illustrated example performs vectorization using GloVE, it should be understood that in other examples, other natural language processing techniques or other vectorization methods may be utilized to convert the received text data into numerical values, including but not limited to transformer architecture models.

Referring still to FIG. 3, the time series data encoding module 314 may encode the time series data received by the time series data reception module 306 into binary data, as disclosed herein. As discussed above, the time series data reception module 306 may receive time series data associated with the equipment 102, 104, 106. However, before this data is input to the model maintained by the computing device 108, the time series data encoding module 314 may encode the received time series into binary data as disclosed herein.

As discussed above, the time series data received by the time series data reception module 306 may indicate sensor readings associated with the equipment 102, 104, 106 over time. Each sensor may have an associated acceptable range of values (e.g., an acceptable temperature range). The acceptable range associated with each sensor may be stored in the data storage component 208. The time series data encoding module 314 may compare measured sensor values for a particular time period to the acceptable range and determine whether the measured value was outside of the range during the time period. As such, the time series data encoding module 314 may encode the time series data into binary data comprising a 1 if the sensor value fell outside of the acceptable range during a specified time period (which is equivalent to an alarm being triggered) and comprising a 0 if the sensor value did not fall outside of the acceptable range during the specified time period (which is equivalent to an alarm not being triggered). The encoded time series data may then be input into the model maintained by the computing device 108.

Referring still to FIG. 3, the model training module 316 trains the model maintained by the computing device 108. As discussed above, the model takes the various data received by the computing device 108 as input and outputs a predicted likelihood of an unplanned event occurring. By combining multiple types of data, the model may provide a more accurate prediction of an unplanned event than using any one data type. In particular, as discussed above, the computing device 108 may receive binary data, categorical data, text data, and/or time series data. In other examples, the computing device 108 may also receive image data (e.g., images of the equipment 102, 104, 106) and/or other types of data that may be input to the model.

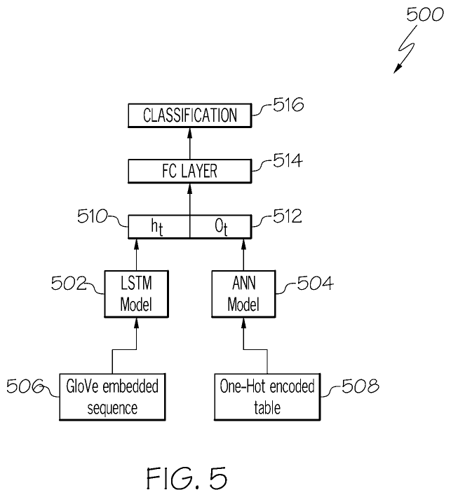

The model maintained by the computing device 108 is a machine learning model that may be trained to predict a likelihood of an unplanned event occurring. An example architecture of the model is shown in FIG. 5. In the example of FIG. 5, the model 500 includes a long-short-term memory (LSTM) model 502 and an artificial neural network (ANN) model 504. The LSTM model 502 may receive vectorized text data, while the ANN model 504 may receive binary data, encoded categorical data, and/or encoded time series data. The outputs of the LSTM model 502 and the ANN model 504 are combined to generate the output of the model 500, as disclosed in further detail below.

The LSTM model 502 comprises a long-short-term-memory (LSTM) deep learning architecture with attention combined with a feed-forward input layer 506, as disclosed herein. LSTM models are memory-based recurrent neural network structures that are ideal for processing sequences of data. As such, the LSTM model 502 is utilized as part of the model 500 to process text data. In particular, vectorized text data output by the text data vectorization module 312 is input to the LSTM model 502. In the example of FIG. 5, an input layer 506 to the LSTM model 502 comprises a GloVe embedded sequence. However, as discussed above, in other examples, the text data vectorization module 312 may utilize natural language processing techniques other than Glo Ve to create the vectorized text data that is input to the LSTM model 502.

A standard LSTM structure cannot detect important inputs for classification. As such, an attention mechanism has been widely adapted for a wide range of deep learning tasks including classification. As such, in the example of FIG. 5, the LSTM model 502 includes an attention layer after the LSTM output layer. An importance score α is assigned to each output vector H=[h1,h2, . . . , hN]. The outputs from the attention layer are weighted outputs from each input vector. The attention mechanism aims to automatically focus on words that have a significant effect on classification to capture the most important words of the input sequence. In the illustrated example, the output of the attention mechanism is input to a softmax activation function for classification. The LSTM model 502 may be trained bi-directionally and batch normalization may be used to improve accuracy. The classification output by the LSTM model 502 comprises a prediction as to whether or not an unplanned event is expected to occur. That is, the LSTM model 502 may classify a state of the manufacturing plant 100 into either a normal operating period, in which a future unplanned event is not predicted, or a pre-failure period, in which a future unplanned event is predicted. The output from the LSTM model 502 is represented as hₜ as shown in block 510 of FIG. 5.

Referring still to FIG. 5, the ANN model 504 comprises an artificial neural network to process data other than the text data. In the example of FIG. 5, an input 508 is shown as One-Hot encoded table, such as the table 402 of FIG. 4B. However, it should be understood that in other examples, the input to the ANN model 504 may comprise any combination of the binary data received by the binary data reception module 300, the encoded categorical data output by the categorical data encoding module 310, and/or the encoded time series data output by the time series data encoding module 314.

In the illustrated example, the ANN model 504 comprises an artificial neural network having 2 hidden layers, with each hidden layer comprising 32 nodes. The hidden layers are activated by the rectifier (ReLU) activation function and the output layer is activated by a sigmoid function. However, in other examples, it should be understood that the ANN model 504 may comprise any number of hidden layers, with each layer having any number of nodes. Any activation function may be used for the hidden layers and the output layer. The output of the ANN model 504 is a binary prediction as to whether an unplanned event is expected to occur. In the example of FIG. 5, the output of the ANN model 504 is represented as oₜ as shown in block 512.

In the example of FIG. 5, the output hₜ from the LSTM model 502 and the output oₜ from the ANN model 504 are concatenated and fed into a fully-connected (FC) layer 514 for classification. The output 516 of the FC layer 514 represents a classification of whether an unplanned event is expected to occur. That is the FC layer 514 may classify a state of the manufacturing plant 100 into either a normal operating period or a pre-failure period.

Referring back to FIG. 3, the model training module 316 trains the model 500. In particular, training data comprising binary data, categorical data, text data, and/or time series data is received for a plurality of days along with ground truth data comprising unplanned event data, as described above. The model training module 316 utilizes the received training data to train the model 500. The model training module 316 may use known machine learning methods to train the model 500 (e.g., using known supervised learning techniques).

In the illustrated example, the input 506 to the LSTM model 502 is an embedded sequence with a maximum sequence length of 200 and embedded dimension of 50. The LSTM model 502 is constructed with 50 neurons with a dropout of 0.2 to reduce overfitting. The model 500 is trained at a learning rate of 0.0001 with weighted cross entropy loss of [0.5, 1] due to the imbalanced data classes. The input 508 to the ANN model 504 is an encoded vector with 117 elements of 0 s and 1 s. The outputs hₜ and oₜ each have a shape of (2,1) and are passed through a linear activation layer with 2 nodes. However, it should be understood that these hyperparameters are only exemplary, and in other examples, other hyperparameters may be used. In embodiments, the model training module 316 may train the model 500 in an end-to-end manner to predict a likelihood of an unplanned event occurring based on the training data. After the model 500 is trained, the trained model may be used to make real-time predictions as to the likelihood of an unplanned event occurring, as disclosed herein.

Referring back to FIG. 3, the unplanned event prediction module 318 may utilize the trained model 500 to predict the likelihood of an unplanned event occurring. In particular, the computing device 108 may receive binary data, categorical data, text data, and/or time series data from the equipment 102, 104, 106. The received data may be pre-processed by the categorical data encoding module 310, the text data vectorization module 312, and/or the time series data encoding module 314 as described above. The unplanned event prediction module 318 may input the pre-processed data into the trained model 500 and may predict the likelihood of an unplanned event occurring based on the output of the model 500.

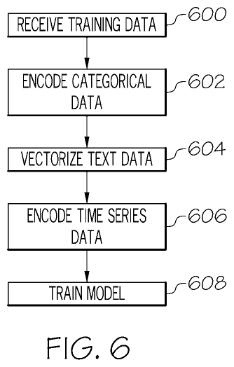

FIG. 6 depicts a flowchart of an example method for training the model 500 to predict a likelihood of an unplanned event. At step 600, the computing device 108 receives training data. In particular, the binary data reception module 300 may receive binary data, the categorical data reception module 302 may receive categorical data, the text data reception module 304 may receive text data, and the time series data reception module 306 may receive time series data. In addition, the unplanned event data reception module 308 may receive unplanned event data as ground truth values. In some examples, the computing device 108 may only receive certain types of data as training data. In particular, the training data may comprise any combination of binary data, categorical data, text data, and/or time series data.

At step 602, the categorical data encoding module 310 encodes the categorical data received by the categorical data reception module 302, as described above. In examples in which the training data does not include categorical data, step 602 may be omitted.

At step 604, the text data vectorization module 312 performs vectorization of the text data received by the text data reception module 304, as described above. In examples in which the training data does not include text data, step 604 may be omitted.

At step 606, the time series data encoding module 314 encodes the time series data received by the time series data reception module 306, as described above. In examples in which the training data does not include time series data, step 606 may be omitted.

At step 608, the model training module 316 trains the model 500, as described above. In particular, supervised learning techniques may be utilized to learn model parameters that minimizes a loss function for prediction of a likelihood that an unplanned event will occur based on the training data. The learned model parameters may be stored on the data storage component 208.

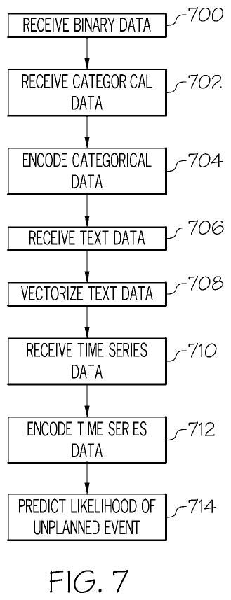

FIG. 7 depicts a flowchart of an example method for utilizing the trained model 500 to predict a likelihood of an unplanned event. As described above, once the model 500 is trained, real-time data associated with the manufacturing plant 100 and/or the equipment 102, 104, 106 may be received by the computing device 108 and input into the trained model to predict a likelihood of an unplanned event, as disclosed herein. The real-time data received by the computing device 108 may include any combination of binary data, categorical data, text data, and/or time series data.

At step 700, the binary data reception module 300 receives binary data. In examples in which binary data is not received, step 700 may be omitted.

At step 702, the categorical data reception module 302 receives categorical data. At step 704, the categorical data encoding module 310 encodes the categorical data as described above. In examples in which categorical data is not received, steps 702 and 704 may be omitted.

At step 706, the text data reception module 304 receives text data. At step 708, the text data vectorization module 312 performs vectorization of the received text data as described above. In examples in which text data is not received, steps 706 and 708 may be omitted.

At step 710, the time series data reception module 306 receives time series data. At step 712, the time series data encoding module 314 encodes the received time series data as described above. In examples in which the time series data is not received, steps 710 and 712 may be omitted.

At step 714, the unplanned event prediction module 318 inputs the received binary data, the encoding categorical data, the vectorized text data, and the encoded time series data into the trained model 500. The unplanned event prediction module 318 then predicts the likelihood of an unplanned event occurring based on an output of the model 500.

It should now be understood that embodiments described herein are directed to systems and methods for determining leading indicator for overall plant health using process data augmented with natural language processing from multiple sources. In particular, a machine learning model may be trained to predict a likelihood of a future unplanned event that may cause production in the manufacturing plant to be reduced based on a combination of binary data, categorical data, text data, and time series data associated with a manufacturing plant and/or equipment in the manufacturing plant. Using multiple data sources allows the machine learning model to more accurately predict unplanned events than using any single data source.

After the model is trained, it may be utilized to predict unplanned events in a manufacturing plant using real-time data. If an unplanned event is predicted, interventions may be taken to prevent the unplanned event from occurring. In some examples, when an unplanned event is predicted, a warning may be presented to one or more human users such that a human can intervene to correct any problems that may cause the unplanned event to occur. In other examples, the system may automatically perform one or more interventions when an unplanned event is predicted, such as modifying the operating conditions of one or more pieces of equipment to correct any problems that may cause the unplanned event to occur.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method comprising:
receiving binary data associated with one or more pieces of equipment in a manufacturing plant, the binary data indicating whether one or more performance variables associated with the one or more pieces of equipment were outside of a predetermined range;
receiving text data associated with the one or more pieces of equipment in the manufacturing plant;
performing a vectorization of the text data using natural language processing techniques to obtain vectorized data;
receiving unplanned event data indicating unplanned events and associated pre-failure periods; and
using the binary data, the vectorized data, and the unplanned event data to train a machine learning model to classify a state of the manufacturing plant between a normal operating period and a pre-failure period.

2. The method of claim 1, further comprising:
receiving categorical data associated with the one or more pieces of equipment, the categorical data indicating whether one or more of the performance variables associated with the one or more pieces of equipment were outside of the predetermined range;
encoding the categorical data to obtain encoded categorical data; and
using the binary data, the vectorized data, and the encoded categorical data to train the machine learning model.

3. The method of claim 1, wherein an unplanned event is an event that causes a production level of the manufacturing plant to decrease by more than a predetermined threshold amount.

4. The method of claim 1, wherein an unplanned event is a safety related or unintended process release event.

5. The method of claim 1, wherein the text data comprises one or more work order requests associated with the one or more pieces of equipment.

6. The method of claim 1, wherein the text data comprises one or more activity entries associated with the one or more pieces of equipment.

7. The method of claim 1, wherein the binary data is associated with one or more pre-defined alarm triggers associated with the one or more pieces of equipment.

8. The method of claim 1, further comprising:
receiving time series data associated with the one or more pieces of equipment; and
generating the binary data based on the time series data.

9. The method of claim 1, further comprising:
performing text processing of the text data to remove punctuation, stop words, and words appearing with a frequency below a predetermined frequency threshold to obtain filtered text data; and
transforming the filtered text data into a numeric representation to obtain the vectorized data.

10. The method of claim 9, further comprising:
combining each word of the filtered text data into a sequence to obtain the vectorized data.

11. The method of claim 1, further comprising:
receiving second binary data associated with the one or more pieces of equipment during a first period of time;
receiving second text data associated with the one or more pieces of equipment during the first period of time;
performing a vectorization of the second text data using the natural language processing techniques to obtain second vectorized data;
inputting the second binary data and the second vectorized data into the machine learning model after the machine learning model has been trained; and
determining a likelihood of the manufacturing plant experiencing an unplanned event based on an output of the machine learning model.

12. The method of claim 11, further comprising:
receiving second categorical data associated with the one or more pieces of equipment during the first period of time;
encoding the second categorical data to obtain second encoded categorical data; and
inputting the second binary data, the second vectorized data, and the second encoded categorical data into the machine learning model after the machine learning model has been trained.

13. A computing device comprising a processor configured to:
receive binary data associated with one or more pieces of equipment in a manufacturing plant, the binary data indicating whether one or more performance variables associated with the one or more pieces of equipment were outside of a predetermined range;
receive text data associated with the one or more pieces of equipment in the manufacturing plant;
perform a vectorization of the text data using natural language processing techniques to obtain vectorized data;
receive unplanned event data indicating unplanned events and associated pre-failure periods; and
use the binary data, the vectorized data, and the unplanned event data to train a machine learning model to classify a state of the manufacturing plant between a normal operating period and a pre-failure period.

14. The computing device of claim 13, wherein the processor is further configured to:
receive categorical data associated with the one or more pieces of equipment, the categorical data indicating whether one or more of the performance variables associated with the one or more pieces of equipment were outside of the predetermined range;
encode the categorical data to obtain encoded categorical data; and
use the binary data, the vectorized data, and the encoded categorical data to train the machine learning model.

15. The computing device of claim 13, wherein the processor is further configured to:
receive time series data associated with the one or more pieces of equipment; and
generate the binary data based on the time series data.

16. The computing device of claim 13, wherein the processor is further configured to:
receive second binary data associated with the one or more pieces of equipment during a first period of time;
receive second text data associated with the one or more pieces of equipment during the first period of time;
perform a vectorization of the second text data using the natural language processing techniques to obtain second vectorized data;
input the second binary data and the second vectorized data into the machine learning model after the machine learning model has been trained; and
determine a likelihood of the manufacturing plant experiencing an unplanned event based on an output of the machine learning model.

17. The computing device of claim 16, wherein the processor is further configured to:
receive second categorical data associated with the one or more pieces of equipment during the first period of time;
encode the second categorical data to obtain second encoded categorical data; and
input the second binary data, the second vectorized data, and the second encoded categorical data into the machine learning model after the machine learning model has been trained.

18. A system comprising:
one or more of pieces of equipment in a manufacturing plant; and
a computing device comprising a processor configured to:
receive binary data associated with one or more pieces of equipment in the manufacturing plant, the binary data indicating whether one or more performance variables associated with the one or more pieces of equipment were outside of a predetermined range;
receive text data associated with the one or more pieces of equipment in the manufacturing plant;
perform a vectorization of the text data using natural language processing techniques to obtain vectorized data;
receive unplanned event data indicating unplanned events and associated pre-failure periods; and
use the binary data, the vectorized data, and the unplanned event data to train a machine learning model to classify a state of the manufacturing plant between a normal operating period and a pre-failure period.

19. The system of claim 18, wherein the processor is further configured to:
receive categorical data associated with the one or more pieces of equipment, the categorical data indicating whether one or more of the performance variables associated with the one or more pieces of equipment were outside of the predetermined range;
encode the categorical data to obtain encoded categorical data; and
use the binary data, the vectorized data, and the encoded categorical data to train the machine learning model.

20. The system of claim 18, wherein the processor is further configured to:
receive second binary data associated with the one or more pieces of equipment during a first period of time;
receive second text data associated with the one or more pieces of equipment during the first period of time;
receive second categorical data associated with the one or more pieces of equipment during the first period of time;
perform a vectorization of the second text data using the natural language processing techniques to obtain second vectorized data;
encode the second categorical data to obtain second encoded categorical data;
input the second binary data, the second vectorized data, and the second encoded categorical data into the machine learning model after the machine learning model has been trained; and
determine a likelihood of the manufacturing plant experiencing an unplanned event based on an output of the machine learning model.
